(19) United States
(12) Patent Application Publication
(10) Pub. No.: US 2025/0290788 A1
(43) Pub. Date: Sep. 18, 2025

(54) OPTICAL FIBER LAYING VEHICLE, OPTICAL FIBER SENSING METHOD, AND NON-TRANSITORY COMPUTER READABLE MEDIUM

(71) Applicant: NEC Corporation, Tokyo (JP)

(72) Inventor: Masafumi EMURA, Tokyo (JP)

(21) Appl. No.: 19/059,524

(22) Filed: Feb. 21, 2025

(30) Foreign Application Priority Data
Mar. 18, 2024 (JP) 2024-041826

(51) Int. Cl. G01H 9/00

(52) U.S. Cl. CPC G01H 9/004

(57) ABSTRACT

An optical fiber laying vehicle according to the present disclosure includes: a wave-transmitter configured to transmit a pinger signal into water; a DAS interrogator configured to acquire, for each of a plurality of points on an optical fiber laid on a seabed, acoustic data indicating a sound resulting from the pinger signal detected at that point; at least one memory configured to store a set of instructions; and at least one processor configured to execute the set of instructions and thereby estimate a shape of the optical fiber by using the acoustic data acquired for each of the plurality of points.

### INCORPORATION BY REFERENCE

This application is based upon and claims the benefit of priority from Japanese patent application No. 2024-041826, filed on Mar. 18, 2024, the disclosure of which is incorporated herein in its entirety by reference.

### TECHNICAL FIELD

The present disclosure relates to an optical fiber laying vehicle, an optical fiber sensing method, and a non-transitory computer readable medium.

### BACKGROUND ART

A DAS (Distributed Acoustic Sensing) interrogator acquires information on vibrations and sounds conveyed to an optical fiber by using backscattered light received from the optical fiber.

Recently, optical fiber sensing systems which use such a DAS interrogator and are used under the sea have been studied and developed.

International Patent Publication No. WO2021/153142 discloses an optical fiber sensing system for acquiring underwater environmental information indicating an environment around an optical fiber laid on the seabed by using a DAS interrogator.

International Patent Publication No. WO2021/111691 discloses an optical fiber sensing system for acquiring underwater environmental information including information on a higher frequency band by using a DAS interrogator.

### SUMMARY

It should be noted that it is necessary to use an optical fiber laid on the seabed in order to detect a target under the sea or on the sea surface by using the optical fiber sensing system disclosed in International Patent Publication No. WO2021/153142 or International Patent Publication No. WO2021/111691.

However, it is difficult to accurately find the position where the optical fiber is laid (hereinafter also referred to as the laying position of the optical fiber), and this difficulty has been responsible for the accuracy of detection of the target position by the optical fiber sensing system being poor.

Therefore, in view of the above-described problem, an object of the present disclosure is to provide an optical fiber laying vehicle, an optical fiber sensing method, and a non-transitory computer readable medium capable of more precisely finding the laying position of an optical fiber.

An optical fiber laying vehicle according to an aspect includes:
a wave-transmitter configured to transmit a pinger signal into water;
a DAS (Distributed Acoustic Sensing) interrogator configured to acquire, for each of a plurality of points on an optical fiber laid on a seabed, acoustic data indicating a sound resulting from the pinger signal detected at that point;
at least one memory configured to store a set of instructions; and
at least one processor configured to execute the set of instructions and thereby estimate a shape of the optical fiber by using the acoustic data acquired for each of the plurality of points.

An optical fiber sensing method according to an aspect is an optical fiber sensing method performed by an optical fiber laying vehicle, including:
transmitting a pinger signal into water;
acquiring, for each of a plurality of points on an optical fiber laid on a seabed, acoustic data indicating a sound resulting from the pinger signal detected at that point; and
estimating a shape of the optical fiber by using the acoustic data acquired for each of the plurality of points.

A non-transitory computer readable medium according to an aspect is a non-transitory computer readable medium storing a program for causing a computer to perform:
a process for transmitting a pinger signal into water;
a process for acquiring, for each of a plurality of points on an optical fiber laid on a seabed, acoustic data indicating a sound resulting from the pinger signal detected at that point; and
a process for estimating a shape of the optical fiber by using the acoustic data acquired for each of the plurality of points.

According to the above-described aspect, it is possible to provide an optical fiber laying vehicle, an optical fiber sensing method, and a non-transitory computer readable medium capable of more precisely finding the laying position of an optical fiber.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 shows an example of a schematic configuration of an optical fiber sensing system according to the present disclosure;

FIG. 2 shows an example of a conception as to how to lay an optical fiber on the seabed by an underwater unmanned vehicle according to the present disclosure;

FIG. 3 shows an example of a transmission signal generated by a pinger transmitter according to the present disclosure;

FIG. 4 shows an example of processes performed by a DAS interrogator and a signal processing computer according to the present disclosure;

FIG. 5 shows an example of points at each of which acoustic data is acquired by a DAS interrogator according to the present disclosure;

FIG. 6 shows an example of a process for calculating a distance from the transmission point of a pinger signal by a signal processing computer according to the present disclosure;

FIG. 7 shows an example of a process for calculating the arriving direction of a pinger signal by a signal processing computer according to the present disclosure;

FIG. 8 shows an example of a process for estimating the shape of an optical fiber by a signal processing computer according to the present disclosure;

FIG. 9 shows an example of a schematic configuration of an optical fiber sensing system according to the present disclosure;

FIG. 10 shows an example of a schematic configuration of an optical fiber sensing system according to the present disclosure;

FIG. 11 shows an example of a schematic configuration of an optical fiber sensing system according to the present disclosure; and

FIG. 12 shows an example of a hardware configuration of a computer by which an underwater unmanned vehicle and a land apparatus according to the present disclosure are implemented.

### EXAMPLE EMBODIMENT

An example embodiment according to the present disclosure will be described hereinafter with reference to the drawings. Note that the following descriptions and drawings are omitted and simplified as appropriate for clarifying the explanation. Further, the same elements are assigned the same reference numerals (or symbols) throughout the drawings, and redundant descriptions thereof are omitted as appropriate.

### First Example Embodiment

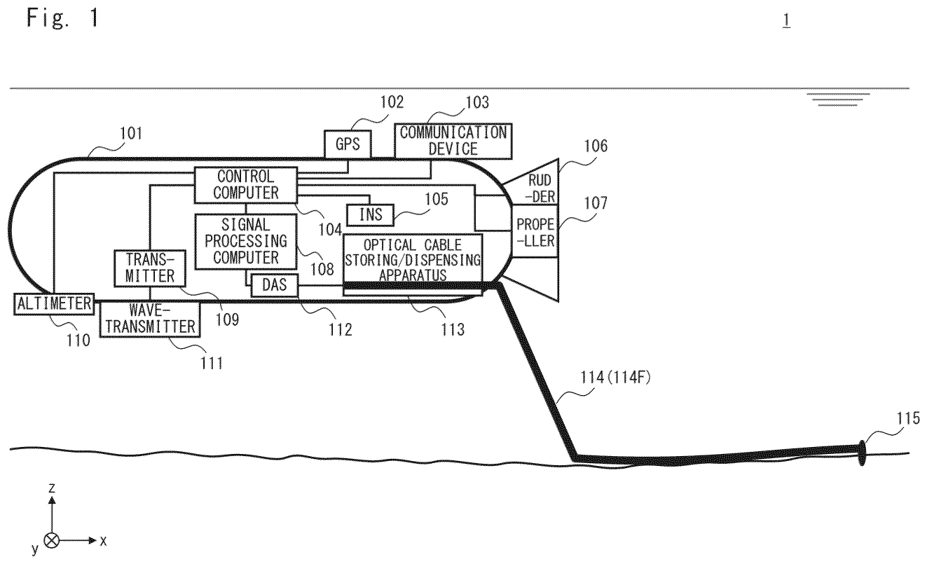

FIG. 1 shows an example of a schematic configuration of an optical fiber sensing system 1.

The optical fiber sensing system 1 includes an underwater unmanned vehicle 101.

The underwater unmanned vehicle 101 is a vehicle used to lay an optical fiber 114F contained in an optical cable 114 on the seabed, and is an example of an optical fiber laying vehicle.

The underwater unmanned vehicle 101 includes a GPS (Global Positioning System) unit 102, a communication device 103, a control computer 104, an INS (Inertial Navigation System) unit 105, a rudder 106, a propeller 107, a signal processing computer 108, a pinger transmitter 109, an altimeter 110, a pinger wave-transmitter 111, a DAS interrogator 112, and an optical cable storing/letting-out apparatus 113. A mooring mechanism 115 is attached to the end of the optical cable 114.

The underwater unmanned vehicle 101 calculates its own position by using the GPS unit 102 when the underwater unmanned vehicle 101 is powered on or is navigating, e.g., moving, on the water. The underwater unmanned vehicle 101 calculates its own position by using the INS unit 105 when it is navigating, e.g., moving, under the water. The underwater unmanned vehicle 101 transmits information indicating its current own position to the control computer 104.

The altimeter 110 is a sensor capable of detecting a distance between the underwater unmanned vehicle 101 and the seabed as an altitude of the underwater unmanned vehicle 101 from the seabed. The altimeter 110 transmits information indicating the current altitude to the control computer 104.

The control computer 104 controls the rudder 106 and the propeller 107 based on the information on the current own position of the underwater unmanned vehicle 101 and the altitude thereof, and by doing so, makes the underwater unmanned vehicle 101 navigate along a route that has been programmed in advance or a route that is determined according to sea-route information received by the communication device 103.

The optical cable storing/letting-out apparatus 113 lets out the optical cable 114. As a result, firstly, the end of the optical cable 114 is fixed in the seabed by the mooring mechanism 115 attached to the end of the optical cable 114. After that, the optical cable 114 and the optical fiber 114F contained in the optical cable 114 are laid on the seabed little by little as the underwater unmanned vehicle 101 moves.

Note that the optical cable storing/letting-out apparatus 113 may let out the optical cable 114 from a position having an altitude equal to or lower than a threshold, i.e., from a position close to the seabed, based on the information of the current altitude of the underwater unmanned vehicle 101. In this way, it is possible to reduce the error of the laying position of the optical fiber 114F (i.e., the position where the optical fiber 114F is laid).

The DAS interrogator 112 is connected to the end of the optical cable 114 located inside the underwater unmanned vehicle 101, i.e., the end of the optical cable 114 opposite to the end thereof fixed in the seabed. The DAS interrogator 112 emits pulsed light into the optical fiber 114F contained in the optical cable 114, and receives, from the optical fiber 114F, backscattered light that has been generated as the pulsed light is transmitted through the optical fiber 114F. By using the backscattered light received from the optical fiber 114F, the DAS interrogator 112 acquires DAS data indicating a sound detected at each point on the optical cable 114.

The DAS interrogator 112 selects a plurality of arbitrary points on the optical cable 114 as points at each of which acoustic data is acquired. Note that the DAS interrogator 112 can select arbitrary points by changing software parameters. The DAS interrogator 112 acquires DAS data at each of the plurality of selected points as acoustic data. The DAS interrogator 112 transmits the acoustic data of each of the plurality of points to the signal processing computer 108.

The signal processing computer 108 performs signal processing on the acoustic data of each of the plurality of points on the optical cable 114. Details of this signal processing will be described later. The signal processing computer 108 transmits the result of the signal processing to the control computer 104.

The pinger transmitter 109 operates under the control of the control computer 104 and generates a transmission signal. The pinger wave-transmitter 111 transmits the transmission signal generated by the pinger transmitter 109 into the water as a pinger signal which is an acoustic signal.

The DAS interrogator 112 acquires, for each of the points on the optical cable 114, DAS data that indicates a sound resulting from the pinger signal transmitted from the pinger wave-transmitter 111 and has been detected at that point.

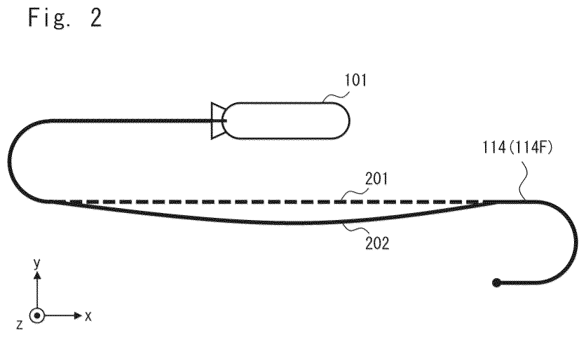

FIG. 2 shows an example of a conception as to how to lay the optical fiber 114F on the seabed by the underwater unmanned vehicle 101. FIG. 2 shows a state in which the seabed is looked down from the surface of the sea.

The underwater unmanned vehicle 101 lays the optical fiber 114F on the seabed. However, a difference occurs between the planned laying position 201 of the optical fiber 114F and the actual laying position 202 thereof.

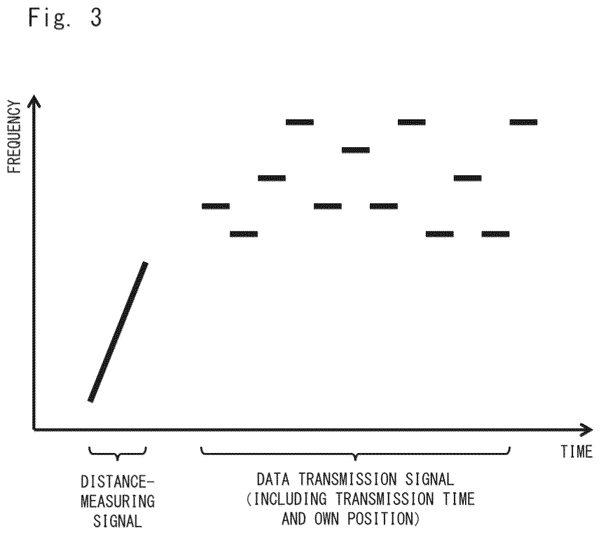

FIG. 3 shows an example of a transmission signal generated by the pinger transmitter 109. In FIG. 3, the horizontal axis indicates the time, and the vertical axis indicates the frequency.

The waveform of the transmission signal generated by the pinger transmitter 109 is a waveform in which the waveform of a distance-measuring signal and the waveform of a data transmission signal are combined with each other. This transmission signal is transmitted as a pinger signal from the pinger wave-transmitter 111 in all directions. The data transmission signal contains information on the transmission time of the pinger signal and information on the own position of the underwater unmanned vehicle 101 at that transmission time.

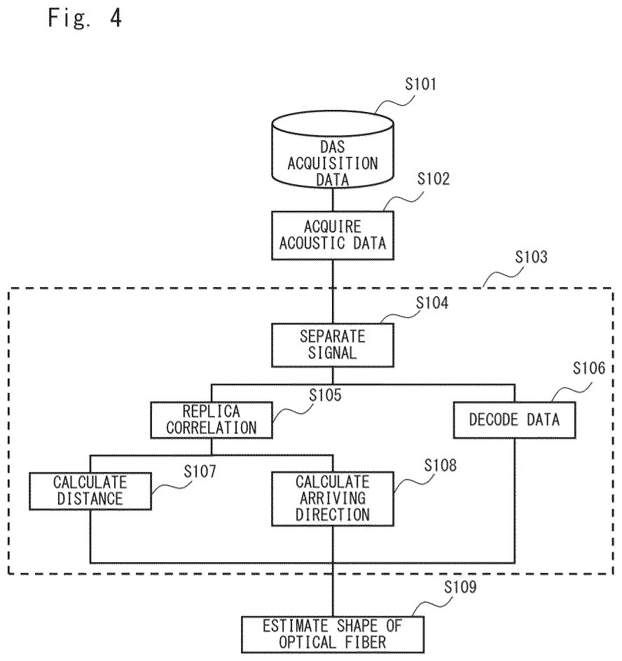

FIG. 4 shows an example of processes performed by the DAS interrogator 112 and the signal processing computer 108.

Firstly, by using backscattered light received from the optical fiber 114F, the DAS interrogator 112 acquires, for each of points on the optical cable 114, DAS data that indicates a sound resulting from the pinger signal transmitted from the pinger wave-transmitter 111 and has been detected at that point (S101).

Next, the DAS interrogator 112 selects a plurality of points on the optical cable 114 and acquires DAS data at each of the selected plurality of points as acoustic data (S102).

Next, the signal processing computer 108 performs, for each of the plurality of points, signal processing on the acoustic data at that point (S103).

In the signal processing in the step S103, the signal processing computer 108 first separates the acoustic data at each point into a position-measuring signal and a data transmission signal (S104).

Next, the signal processing computer 108 performs a data decoding process on the data transmission signal (S106). As a result, information on the transmission time of the pinger signal and information on the own position of the underwater unmanned vehicle 101 at that transmission time (i.e., the transmission point of the pinger signal), both of which are contained in the data transmission signal, are decoded.

Further, the signal processing computer 108 performs a replica correlation process on the position-measuring signal (S105). Next, the signal processing computer 108 calculates the distance from the transmission point of the pinger signal and calculates the direction from which the pinger signal has arrived (hereinafter also referred to as the arriving direction of the pinger signal) (S107 and S108).

After that, the signal processing computer 108 estimates the shape of the optical fiber 114F by using the information on the distance from the transmission point of the pinger signal and the arriving direction of the pinger signal, calculated for each of the plurality of points on the optical cable 114 and the information decoded from the data transmission signal (S109).

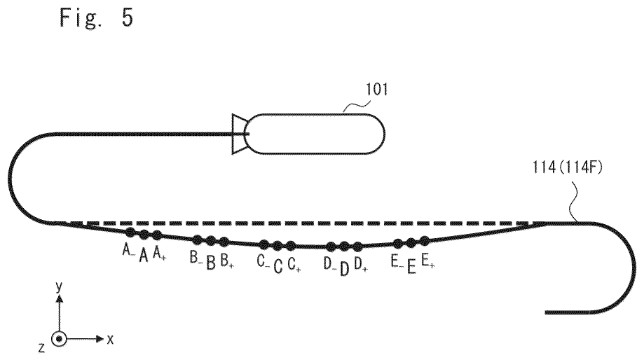

FIG. 5 shows an example of points at each of which acoustic data is acquired by the DAS interrogator 112.

In the example shown in FIG. 5, the DAS interrogator 112 selects five points A to E, and acquires acoustic data at three sub-points for each of the five selected points. For example, for the point A, the DAS interrogator 112 acquires acoustic data at the point A, and also acquires acoustic data at a point A₋ and at a point A₊, both of which are a distance a away from the point A.

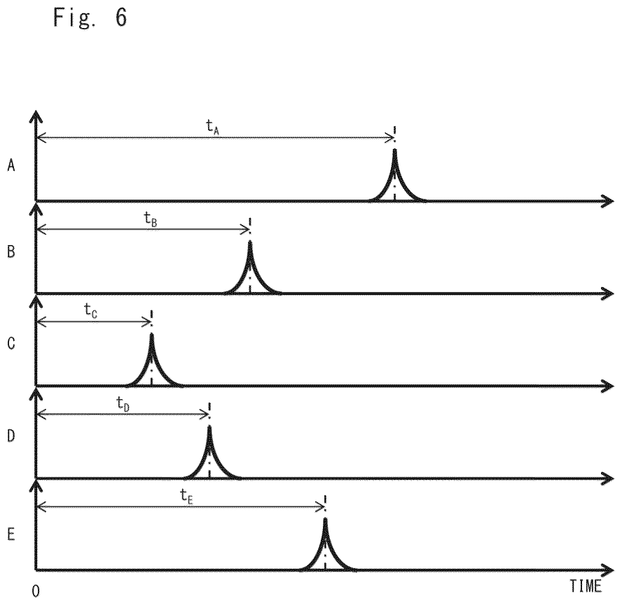

FIG. 6 shows an example of a process for calculating a distance from the transmission point of the pinger signal by the signal processing computer 108. In FIG. 6, the horizontal axis indicates the time, and the vertical axis indicates the sound intensity at each point. In FIG. 6, the transmission time of the pinger signal is defined as a time 0.

In the example shown in FIG. 6, for each of the five points A to E, the distance from the transmission point of the pinger signal to that point is calculated.

The signal processing computer 108 obtains, for each of points X (X=A, B, C, D and E; the same applies hereinafter), information on the transmission time and transmission position of the pinger signal by performing a data decoding process on the data transmission signal.

Further, the signal processing computer 108 also derives, for each of the points X, the time at which a peak occurs in the sound intensity for a signal that is obtained by performing a replica correlation process on the position-measuring signal at that point.

Then, the signal processing computer 108 derives a time difference tₓ between the time at which the peak occurred and the transmission time of the pinger signal, and calculates the distance from the transmission point of the pinger signal by using the derived time difference tₓ.

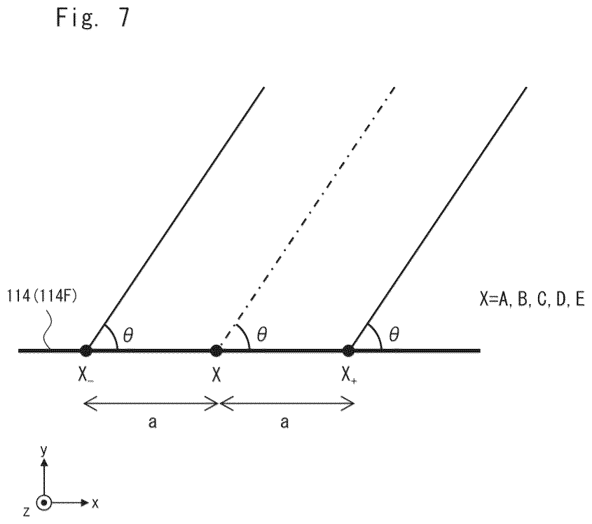

FIG. 7 shows an example of a process for calculating the arriving direction of the pinger signal by the signal processing computer 108.

In the example shown in FIG. 7, for each of the five points A to E, the arriving direction of the pinger signal at that point is calculated.

The signal processing computer 108 derives a phase difference between a signal that is obtained by performing a replica correlation process on the position-measuring signal at the point X₋, which is the distance a away from the point X, and a signal that is obtained by performing a replica correlation process on the position-measuring signal at the point X₊, which is the distance a away from the point X.

Then, the signal processing computer 108 calculates, for each of the points X, the arriving direction θ of the pinger signal at that point by using the phase difference derived for that point X.

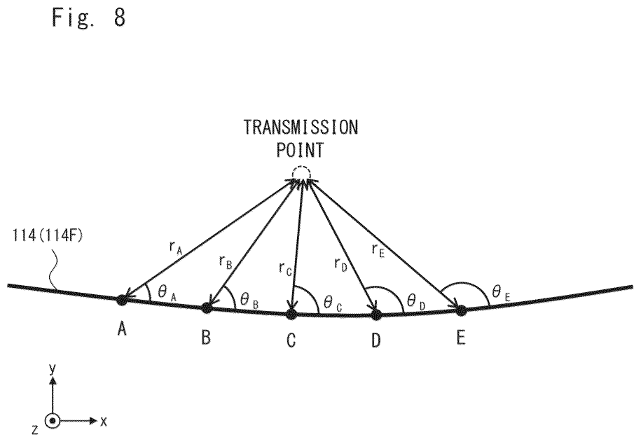

FIG. 8 shows an example of a process for estimating the shape of the optical fiber 114F by the signal processing computer 108.

In the example shown in FIG. 8, for each of the five points A to E on the optical cable 114, information on the distance from the transmission point of the pinger signal and the arriving direction thereof have already been obtained. Further, information on the transmission point of the pinger signal has also already been obtained.

Therefore, the signal processing computer 108 estimates the shape of the optical fiber 114F by using the information on the transmission point of the pinger signal and the information on the distance from the transmission point of the pinger signal and the arriving direction thereof obtained for each of the five points A to E.

Specifically, the signal processing computer 108 first estimates the position of each of the five points A to E on the optical cable 114 by using the information described above. Then, the signal processing computer 108 estimates the shape of the optical fiber 114F by using the position of each of the five points A to E on the optical cable 114.

Note that after laying the optical fiber 114F, the signal processing computer 108 and the DAS interrogator 112 installed in the underwater unmanned vehicle 101 perform underwater monitoring by using the optical fiber 114F. When the target is detected by the underwater monitoring, the detection of the target is reported to the outside by the communication device 103 or the like under the control of the control computer 104.

As described above, according to the first example embodiment, the pinger wave-transmitter 111 transmits a pinger signal into the water. The DAS interrogator 112 acquires, for each of a plurality of points on the optical fiber 114F laid on the seabed, acoustic data indicating a sound resulting from the pinger signal detected at that point. The signal processing computer 108 estimates the shape of the optical fiber 114F by using the acoustic data acquired for each of the plurality of points.

As shown in FIG. 2, when the optical fiber 114F is laid, a difference occurs between the planned laying position 201 and the actual laying position 202.

However, according to the first example embodiment, after the optical fiber 114F is laid, the shape of the optical fiber 114F is estimated by using acoustic data obtained for each of a plurality of points on the optical fiber 114F. In this way, it is possible to find the laying position of the optical fiber 114F more precisely.

Further, the altimeter 110 detects the altitude of the underwater unmanned vehicle 101 from the seabed, and the optical cable storing/letting-out apparatus 113 can let out, i.e., unwind and let out, the optical cable 114 from a position close to the seabed by using the detected altitude. In this way, it is possible to reduce the error of the laying position of the optical fiber 114F.

Further, the DAS interrogator 112 selects a plurality of points at each of which acoustic data is acquired. Note that the DAS interrogator 112 can select arbitrary points by changing software parameters. Therefore, it is possible to select points suitable for estimating the shape of the optical fiber 114F and acquire acoustic data at each of these points even in the case where the points are different from the points used for the underwater monitoring, which is the original purpose of the optical fiber 114F.

### Second Example Embodiment

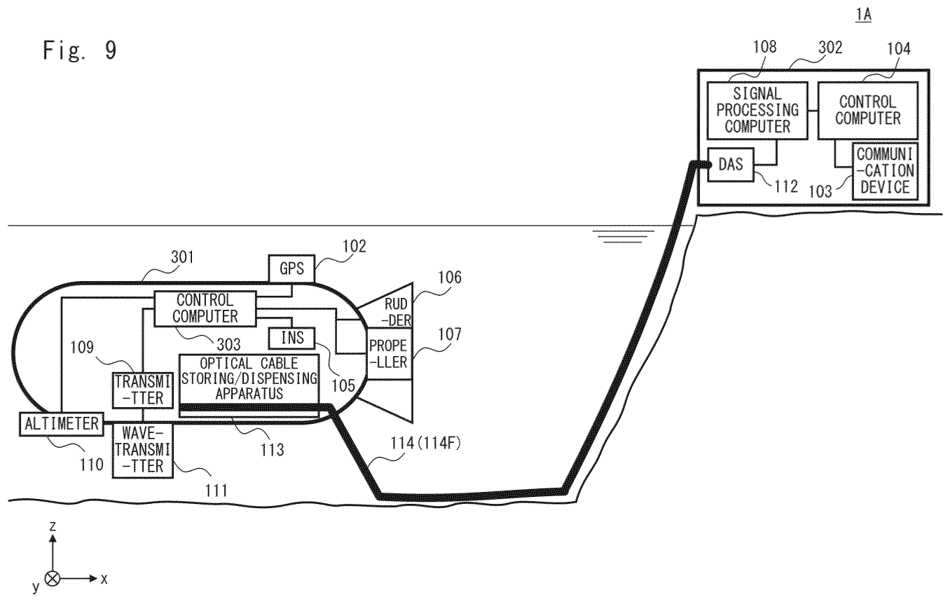

FIG. 9 shows an example of a schematic configuration of an optical fiber sensing system 1A.

The optical fiber sensing system 1A includes an underwater unmanned vehicle 301 and a land apparatus 302, which is a facility on land.

The underwater unmanned vehicle 301 includes a GPS unit 102, a control computer 303, an INS unit 105, a rudder 106, a propeller 107, a pinger transmitter 109, an altimeter 110, a pinger wave-transmitter 111, and an optical cable storing/letting-out apparatus 113.

The land apparatus 302 includes a communication device 103, a control computer 104, a signal processing computer 108, and a DAS interrogator 112.

That is, in the optical fiber sensing system 1A, the communication device 103, the control computer 104, the signal processing computer 108, and the DAS interrogator 112, all of which are provided in the underwater unmanned vehicle 101 in the first example embodiment, are provided in the land apparatus 302.

In the optical fiber sensing system 1A, it is necessary to synchronize the time in the underwater unmanned vehicle 301 with the time in the signal processing computer 108 provided in the land apparatus 302 in order to estimate the shape of the optical fiber 114F.

Meanwhile, since underwater monitoring can be performed by the land apparatus 302, which is the facility on land, alone, the optical fiber sensing system 1A can be constructed in a simple manner.

The rest of the configuration of the second example embodiment is similar to that of the above-described first example embodiment. Therefore, the second example embodiment can provide effects similar to those obtained in the above-described first example embodiment.

### Third Example Embodiment

A third example embodiment corresponds to an example embodiment obtained by generalizing the above-described first example embodiment.

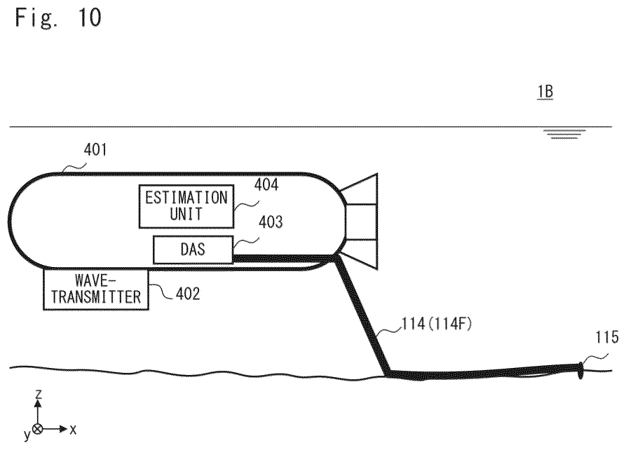

FIG. 10 shows an example of a schematic configuration of an optical fiber sensing system 1B.

The optical fiber sensing system 1B includes an underwater unmanned vehicle 401. The underwater unmanned vehicle 401 is an example of the optical fiber laying vehicle.

The underwater unmanned vehicle 401 includes a wave-transmitter 402, a DAS interrogator 403, and an estimation unit 404.

The wave-transmitter 402 transmits a pinger signal into the water. The wave-transmitter 402 corresponds to the pinger transmitter 109 and the pinger wave-transmitter 111.

The DAS interrogator 403 acquires, for each of a plurality of points on the optical fiber 114F laid on the seabed, acoustic data indicating a sound resulting from the pinger signal detected at that point. The DAS interrogator 403 corresponds to the DAS interrogator 112.

The estimation unit 404 estimates the shape of the optical fiber 114F by using the acoustic data acquired for each of the plurality of points on the optical fiber 114F. The estimation unit 404 corresponds to the signal processing computer 108.

As described above, according to the third example embodiment, after the optical fiber 114F is laid, the shape of the optical fiber 114F is estimated by using acoustic data obtained for each of a plurality of points on the optical fiber 114F. In this way, it is possible to find the laying position of the optical fiber 114F more precisely.

Note that the underwater unmanned vehicle 401 may further include a position calculation unit for calculating the position of the underwater unmanned vehicle 401. This position calculation unit corresponds to the GPS unit 102 and the INS unit 105. In this case, the pinger signal may contain a distance-measuring signal and a data transmission signal. Further, the data transmission signal may contain information on the transmission time of the pinger signal, and also contain the position of the underwater unmanned vehicle 401 at the transmission time of the pinger signal as information on the transmission point of the pinger signal.

Further, the estimation unit 404 may separate, for each of a plurality of points on the optical fiber 114F, the distance-measuring signal and the data transmission signal from the acoustic data of that point. Further, the estimation unit 404 may acquire, for each of the plurality of points on the optical fiber 114F, information on the transmission point and the transmission time of the pinger signal by decoding the data transmission signal, and may perform a replica correlation process on the distance-measuring signal of that point. Further, the estimation unit 404 may estimate, for each of the plurality of points on the optical fiber 114F, the position of that point by using the distance-measuring signal of that point that has been subjected to the replica correlation process and the transmission point and the transmission time of the pinger signal, and may estimate the shape of the optical fiber 114F by using the position of each of the plurality of points.

Further, the estimation unit 404 may calculate, for each of the plurality of points on the optical fiber 114F, the distance from the transmission point of the pinger signal to that point by using the distance-measuring signal of that point that has been subjected to the replica correlation process and the transmission point and the transmission time of the pinger signal, and also calculate the arriving direction of the pinger signal at that point. Further, the estimation unit 404 may estimate, for each of the plurality of points on the optical fiber 114F, the position of that point by using the transmission point of the pinger signal, and the distance and the arriving direction calculated for that point.

Further, the underwater unmanned vehicle 401 may further include an optical cable storing/letting-out apparatus for storing an optical cable 114 containing an optical fiber 114F and letting out the optical cable 114 into the water, and thereby for laying the optical fiber 114F on the seabed. The optical cable storing/letting-out apparatus corresponds to the optical cable storing/letting-out apparatus 113.

Further, the underwater unmanned vehicle 401 may further include an altimeter for detecting a distance between the underwater unmanned vehicle 401 and the seabed as an altitude. This altimeter corresponds to the altimeter 110. In this case, the optical cable storing/letting-out apparatus may let out the optical cable 114 into the water when the altitude of the underwater unmanned vehicle 401 is equal to or lower than a predetermined threshold.

Further, when the optical fiber 114F is laid on the seabed by the optical cable storing/letting-out apparatus, the wave-transmitter 402 may transmit a pinger signal into the water; the DAS interrogator 403 may acquire acoustic data at each of a plurality of points on the optical fiber 114F; and the estimation unit 404 may estimate the shape of the optical fiber 114F.

### Fourth Example Embodiment

A fourth example embodiment corresponds to an example embodiment obtained by generalizing the above-described second example embodiment.

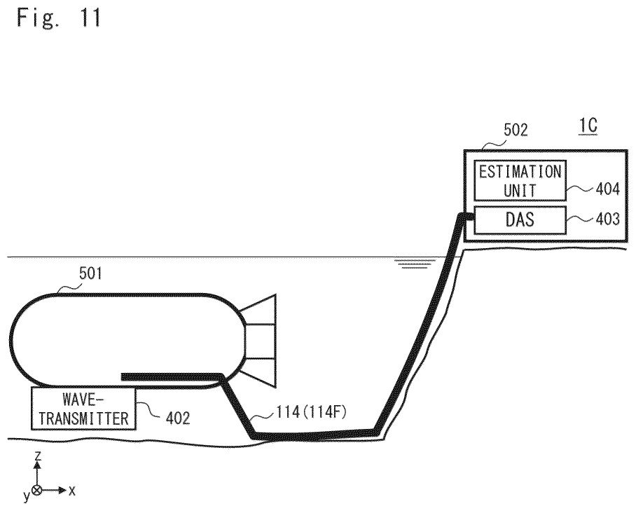

FIG. 11 shows an example of a schematic configuration of an optical fiber sensing system 1C.

The optical fiber sensing system 1C includes an underwater unmanned vehicle 501 and a land apparatus 502, which is a facility on land.

The underwater unmanned vehicle 501 includes a wave-transmitter 402.

The land apparatus 502 includes a DAS interrogator 403 and an estimation unit 404.

That is, in the optical fiber sensing system 1C, the DAS interrogator 403 and the estimation unit 404, both of which are provided in the underwater unmanned vehicle 401 in the third example embodiment, are provided in the land apparatus 302, which is the facility on land.

The rest of the configuration of the fourth example embodiment is similar to that of the above-described third example embodiment. Therefore, the fourth example embodiment can provide effects similar to those obtained in the above-described third example embodiment.

### Other Example Embodiment

In each of the above-described example embodiments, an example in which the optical fiber laying vehicle is the underwater unmanned vehicle 101 has been described, but the configuration according to the present invention is not limited to these examples. The optical fiber laying vehicle may be a water-surface unmanned vehicle, a manned ship, a submarine, or the like.

Further, in each of the above-described example embodiments, the shape of the optical fiber 114F is estimated when the optical fiber 114F is laid, but the configuration according to the present invention is not limited to these examples. The shape of the optical fiber 114F may be estimated again in order to correct for the deviation in position of the optical cable 114 at the timing when a certain time has elapsed since the optical fiber 114F was laid.

### Hardware Configurations of Underwater Unmanned Vehicle and Land Apparatus

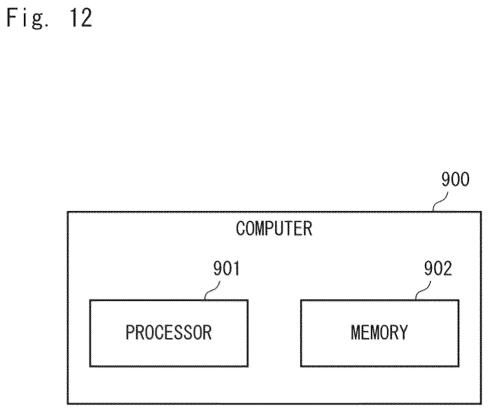

FIG. 12 shows an example of a hardware configuration of a computer 900 by which the function of each of the underwater unmanned vehicles 101, 301, 401 and 501, and the land apparatuses 302 and 502 is implemented. Note that the computer 900 may implement the functions of all of the underwater unmanned vehicles 101, 301, 401 and 501, and the land apparatuses 302 and 502, or may implement some of these functions.

The computer 900 includes a processor 901 and a memory 902. The processor 901 and the memory 902 are connected to each other.

The processor 901 may be, for example, a microprocessor, an MPU (Micro Processing Unit), or a CPU (Central Processing Unit). The processor 901 may include a plurality of processors.

The memory 902 may be formed by a combination of a volatile memory and a non-volatile memory. The memory 902 may include a storage remotely located from the processor 901. In this case, the processor 901 may access the memory 902 through an I (Input)/O (Output) interface (not shown).

In the memory 902, a software module(s) (computer program(s)) including instructions and data for performing the processes performed by the underwater unmanned vehicles 101, 301, 401 and 501, and the land apparatuses 302 and 502 described above may be stored.

Further, in some implementations, the processor 901 may be configured so as to perform the processes performed by the underwater unmanned vehicles 101, 301, 401 and 501, and the land apparatuses 302 and 502 described above by loading the software module from the memory 902 and executing the loaded software module.

Further, the above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

An optical fiber laying vehicle comprising:
a wave-transmitter configured to transmit a pinger signal into water;
a DAS (Distributed Acoustic Sensing) interrogator configured to acquire, for each of a plurality of points on an optical fiber laid on a seabed, acoustic data indicating a sound resulting from the pinger signal detected at that point;
at least one memory configured to store a set of instructions; and
at least one processor configured to execute the set of instructions and thereby estimate a shape of the optical fiber by using the acoustic data acquired for each of the plurality of points.

### (Supplementary Note 2)

The optical fiber laying vehicle described in Supplementary note 1, wherein
the at least one processor is configured to execute the set of instructions and thereby calculate the position of the optical fiber laying vehicle,
the pinger signal contains a distance-measuring signal and a data transmission signal, and
the data transmission signal contains information on a transmission time of the pinger signal, and also contains the position of the optical fiber laying vehicle at the transmission time of the pinger signal as information on a transmission point of the pinger signal.

### (Supplementary Note 3)

The optical fiber laying vehicle described in Supplementary note 2, wherein the at least one processor is configured to execute the set of instructions and thereby:
separate, for each of the plurality of points, the distance-measuring signal and the data transmission signal from the acoustic data of that point;
acquire, for each of the plurality of points, information on a transmission point and a transmission time of the pinger signal by decoding the data transmission signal of that point;
perform, for each of the plurality of points, a replica correlation process on the distance-measuring signal of that point;
estimate, for each of the plurality of points, a position of that point by using the distance-measuring signal of that point that has been subjected to the replica correlation process and the transmission point and the transmission time of the pinger signal; and
estimate the shape of the optical fiber by using the position of each of the plurality of points.

### (Supplementary Note 4)

The optical fiber laying vehicle described in Supplementary note 3, wherein the at least one processor is configured to execute the set of instructions and thereby:
calculate, for each of the plurality of points, a distance from the transmission point of the pinger signal to that point by using the distance-measuring signal of that point that has been subjected to the replica correlation process and the transmission point and the transmission time of the pinger signal, and also calculate an arriving direction of the pinger signal at that point; and
estimate, for each of the plurality of points, a position of that point by using the transmission point of the pinger signal, and the distance and the arriving direction calculated for that point.

### (Supplementary Note 5)

The optical fiber laying vehicle described in Supplementary note 1, further comprising an optical cable storing/letting-out apparatus configured to store an optical cable containing the optical fiber, and let out the optical cable into water and thereby lay the optical fiber on the seabed.

### (Supplementary Note 6)

The optical fiber laying vehicle described in Supplementary note 5, further comprising an altimeter configured to detect a distance between the optical fiber laying vehicle and the seabed as an altitude, wherein
the optical cable storing/letting-out apparatus lets out the optical cable into water when the altitude is equal to or lower than a predetermined threshold.

### (Supplementary Note 7)

The optical fiber laying vehicle described in Supplementary note 5, wherein when the optical fiber is laid on the seabed by the optical cable storing/letting-out apparatus, the wave-transmitter transmits the pinger signal into water; the DAS interrogator acquires the acoustic data at each of a plurality of points; and the at least one processor estimates the shape of the optical fiber.

### (Supplementary Note 8)

The optical fiber laying vehicle described in Supplementary note 1, wherein the optical fiber laying vehicle is an underwater unmanned vehicle, a water-surface unmanned vehicle, a manned ship, or a manned submarine.

### (Supplementary Note 9)

An optical fiber sensing system comprising:
an optical fiber laying vehicle; and
a land apparatus, wherein
the optical fiber laying vehicle comprises a wave-transmitter configured to transmit a pinger signal into water, and
the land apparatus comprises:
a DAS (Distributed Acoustic Sensing) interrogator configured to acquire, for each of a plurality of points on an optical fiber laid on a seabed, acoustic data indicating a sound resulting from the pinger signal detected at that point;
at least one memory configured to store a set of instructions; and
at least one processor configured to execute the set of instructions and thereby estimate a shape of the optical fiber by using the acoustic data acquired for each of the plurality of points.

### (Supplementary Note 10)

An optical fiber sensing method performed by an optical fiber laying vehicle, comprising:
transmitting a pinger signal into water;
acquiring, for each of a plurality of points on an optical fiber laid on a seabed, acoustic data indicating a sound resulting from the pinger signal detected at that point; and
estimating a shape of the optical fiber by using the acoustic data acquired for each of the plurality of points.

### (Supplementary Note 11)

A non-transitory computer readable medium storing a program for causing a computer to perform:
a process for transmitting a pinger signal into water;
a process for acquiring, for each of a plurality of points on an optical fiber laid on a seabed, acoustic data indicating a sound resulting from the pinger signal detected at that point; and
a process for estimating a shape of the optical fiber by using the acoustic data acquired for each of the plurality of points.

Note that, some or all of elements (e.g., structures and functions) specified in Supplementary Notes 2 to 8 dependent on Supplementary Note 1 may also be dependent on Supplementary Notes 9-11 in dependency similar to that of Supplementary Notes 2 to 8 dependent on Supplementary Note 1. Some or all of elements specified in any of Supplementary Notes may be applied to various types of hardware, software, and recording means for recording software, systems, and methods.

What is claimed is:

1. An optical fiber laying vehicle comprising:
a wave-transmitter configured to transmit a pinger signal into water;
a DAS (Distributed Acoustic Sensing) interrogator configured to acquire, for each of a plurality of points on an optical fiber laid on a seabed, acoustic data indicating a sound resulting from the pinger signal detected at that point;
at least one memory configured to store a set of instructions; and
at least one processor configured to execute the set of instructions and thereby estimate a shape of the optical fiber by using the acoustic data acquired for each of the plurality of points.

2. The optical fiber laying vehicle according to claim 1, wherein
the at least one processor is configured to execute the set of instructions and thereby calculate the position of the optical fiber laying vehicle,
the pinger signal contains a distance-measuring signal and a data transmission signal, and
the data transmission signal contains information on a transmission time of the pinger signal, and also contains the position of the optical fiber laying vehicle at the transmission time of the pinger signal as information on a transmission point of the pinger signal.

3. The optical fiber laying vehicle according to claim 2, wherein the at least one processor is configured to execute the set of instructions and thereby:
separate, for each of the plurality of points, the distance-measuring signal and the data transmission signal from the acoustic data of that point;
acquire, for each of the plurality of points, information on a transmission point and a transmission time of the pinger signal by decoding the data transmission signal of that point;
perform, for each of the plurality of points, a replica correlation process on the distance-measuring signal of that point;
estimate, for each of the plurality of points, a position of that point by using the distance-measuring signal of that point that has been subjected to the replica correlation process and the transmission point and the transmission time of the pinger signal; and
estimate the shape of the optical fiber by using the position of each of the plurality of points.

4. The optical fiber laying vehicle according to claim 3, wherein the at least one processor is configured to execute the set of instructions and thereby:
calculate, for each of the plurality of points, a distance from the transmission point of the pinger signal to that point by using the distance-measuring signal of that point that has been subjected to the replica correlation process and the transmission point and the transmission time of the pinger signal, and also calculate an arriving direction of the pinger signal at that point; and
estimate, for each of the plurality of points, a position of that point by using the transmission point of the pinger signal, and the distance and the arriving direction calculated for that point.

5. The optical fiber laying vehicle according to claim 1, further comprising an optical cable storing/letting-out apparatus configured to store an optical cable containing the optical fiber, and let out the optical cable into water and thereby lay the optical fiber on the seabed.

6. The optical fiber laying vehicle according to claim 5, further comprising an altimeter configured to detect a distance between the optical fiber laying vehicle and the seabed as an altitude, wherein
the optical cable storing/letting-out apparatus lets out the optical cable into water when the altitude is equal to or lower than a predetermined threshold.

7. The optical fiber laying vehicle according to claim 5, wherein when the optical fiber is laid on the seabed by the optical cable storing/letting-out apparatus, the wave-transmitter transmits the pinger signal into water; the DAS interrogator acquires the acoustic data at each of a plurality of points; and the at least one processor estimates the shape of the optical fiber.

8. The optical fiber laying vehicle according to claim 1, wherein the optical fiber laying vehicle is an underwater unmanned vehicle, a water-surface unmanned vehicle, a manned ship, or a manned submarine.

9. An optical fiber sensing method performed by an optical fiber laying vehicle, comprising:
transmitting a pinger signal into water;
acquiring, for each of a plurality of points on an optical fiber laid on a seabed, acoustic data indicating a sound resulting from the pinger signal detected at that point; and
estimating a shape of the optical fiber by using the acoustic data acquired for each of the plurality of points.

10. A non-transitory computer readable medium storing a program for causing a computer to perform:
a process for transmitting a pinger signal into water;
a process for acquiring, for each of a plurality of points on an optical fiber laid on a seabed, acoustic data indicating a sound resulting from the pinger signal detected at that point; and
a process for estimating a shape of the optical fiber by using the acoustic data acquired for each of the plurality of points.
